(19) United States
(12) Patent Application Publication
(10) Pub. No.: US 2004/0095349 A1
(43) Pub. Date: May 20, 2004

(54) Method for visualizing multidimensional data

(75) Inventors: Yoshitaka Bito, Cupertino, CA (US); Yoichi Shintani, Palo Alto, CA (US); Taiki Sakata, Sunnyvale, CA (US); Hitoshi Matsuo, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi America, Ltd., Brisbane, CA

(21) Appl. No.: 10/714,254

(22) Filed: Nov. 14, 2003

Related U.S. Application Data
(63) Continuation of application No. 09/687,058, filed on Oct. 12, 2000, now abandoned.

(51) Int. Cl. G06T 11/20

(52) U.S. Cl. 345/440

(57) ABSTRACT

According to the invention, visualization and analysis of multidimensional data is performed in an automated environment. Embodiments according to the present invention are especially effective for analyzing the course of clinical procedures, but it is not only limited to these types of applications. The present invention can also be applied to healthcare risk analysis for many factors, analyses of industrial production control, and any analyses using multidimensional data. The present invention provides systems, methods and software that can be used to distribute and share the results of analyses.

### CROSS-REFERENCE TO RELATED APPLICATIONS

The present invention is a continuation application of U.S. application Ser. No. 09/687,058, filed Oct. 12, 2000 which is herein incorporated by reference for all purposes.

### BACKGROUND OF THE INVENTION

The present invention relates generally to visualizing and analyzing multidimensional data, and more specifically to methods, systems and computer software for performing process analyses, including clinical pathways analysis.

Broadly defined, clinical pathways analysis refers to analyzing a course of clinical procedures. Sometimes, clinical pathways analysis is called critical pathways analysis.

Conventional data analysis techniques are lacking in the area of processing complex data analysis requests, such as those that might arise in performing a clinical pathways analysis. For example, processing a request, such as “I want to see the course of procedure of the patients who were treated very differently from the others,” or “I want to see the difference in patterns of procedures among doctors, especially for focusing on the doctor who uses the most cost-troubled procedures,” are difficult for conventional approaches to answer. One reason is that such requests comprise of two or more questions from different points of view, and the result of the first question affects the answer to the next question. In another example, processing a request such as, “I want to compare the pattern of procedures between two patient groups who may have had a Procedure-A applied to them on the admission day” is difficult for conventional approaches, because this request applies a dynamically created categorization created to the patients. Another area that conventional techniques can benefit from improvement is in the interchange of the information between visualizing the results and providing the user an environment for the user's interaction with multidimensional data.

What is really needed is a method that efficiently answers complex requests about data, and that is capable of operating with dynamic categorization.

### SUMMARY OF THE INVENTION

The invention provides interactive visualization techniques. One technique uses graphs not only for visualizing data from multiple points of view, but also for guiding users in selecting subsets of the data. The selection of subsets in one graph reflects the calculation and visualization of the other graphs, which dynamically categorizes the data in certain dimensions. This selection-visualization interaction among the graphs can operate forward as well as backwards. The approaches to clinical pathway analysis of the present invention can provide a clear presentation of the information, so that the difference of the pattern and distribution can be easily grasped, and flexibility in selecting the patient groups or procedures in specific embodiments.

Clinical pathways analysis comprises the following types of analyses: (1) visualizing time-course of a clinical procedure, (2) comparing the time-course of the clinical procedure as applied to selected patients or patient groups, (3) visualizing an amount of the clinical procedure for each patient or patient group, (4) comparing the amounts of clinical procedures for each patient among the selected procedures, and (5) categorizing patients and procedures dynamically.

The invention provides visualization techniques for process analysis, which includes an analysis of clinical procedures. In process analysis, process data is abstracted into three or more dimensions, such as for example, a process, a time and a type of procedure. A plurality of visualization devices for process analysis comprises in a specific embodiment of a two-dimensional map and a one-dimensional bar- or line-graph, which enable visualizing the data in three dimensions. The two-dimensional map shows a pattern or a correlation between two dimensions, such as a time and a type of procedure, for example. The one-dimensional graph shows a quantity along one dimension, such as each process. Regions of interest (ROI) on the dimensions can be selected on each graph, which enables easily selecting target points of interest while confirming them on the graph. The information comprising the selected ROI is interchanged and the data is sliced according to the ROI. This slicing comprises calculating a subset of data of which values in the corresponding dimensions are in the ROI. The other graphs are re-drawn using the sliced data. This function enables the user to dynamically categorize the data by selecting the ROI. Further, it enables slicing the multi-dimensional data in some dimensions while confirming the results in other dimensions. Yet further, it enables the user to compare certain regions, and to determine majority or to pick up outliers.

The invention further provides, in specific embodiments, a method for analyzing process data that comprises a variety of elements. The method can include abstracting the process data into three or more dimensions. The three dimensions comprise, for example, a process dimension, a time dimension, and a type of procedure dimension in a specific embodiment. The method also includes providing a plurality of visualization devices enabling visualization of the process data one or more of the three dimensions. The visualization devices can be, for example, a two-dimensional map (2D-map) and a one-dimensional graph (1D-graph). Furthermore, a combination of visualization device types, not limited to the 2D-map and the 1D-graph, may be used in some specific embodiments. For example, the 1D-graph can be replaced by a second 2D-map to show four-dimensional data, or the 2D-map can be replaced by a 2D-scatter graph to show the distribution of data, in various specific embodiments. The one-dimensional graph can be a bar graph, a line graph, a pie chart, scatter-gram, and the like. The method includes indicating one or more correlations between two or more of the dimensions using a first visualization device and indicating a quantity measure, for example, by one or more of the three dimensions using a second visualization device. A selection of one or more regions of interest (ROI) is received from the user according to the method. The selection is made from one or more dimensions chosen from among the three dimensions. The selection is indicated on one or both of the first visualization device and the second visualization device. Then, the method provides for exchanging information about the selected ROI between the first visualization device and the second visualization device. Then, a first subset of the process data is calculated based upon values present in the ROI along one or more of the three dimensions. The method provides for redrawing the first visualization device and the second visualization device based upon the first subset of the process data.

In specific embodiments, a third visualization device is also provided. This third visualization device indicates one or more correlations between the three dimensions, for example. In these embodiments, the method displays one or more of the first visualization device, the second visualization device, and the third visualization device on a computer screen.

In another representative embodiment, the method can include receiving a second selection of one or more of the plurality of regions of interest (ROI). This second selection is from one or more dimensions chosen from among the three dimensions. The second selection is indicated on the first visualization device and/or the second visualization device. The method also includes calculating a second subset of the process data. The second subset comprises values present in the second selection of regions of interest along one or more of the three dimensions. Displaying the first subset of the process data and the second subset of the process data together on one or both of the first visualization device and the second visualization device is also included in the method.

In specific embodiments, a function, such as an addition, a subtraction, a multiplication, an exponentiation, a division, a root, a boolean operator, a modulo, an absolute value, and the like can be applied to the first subset and second subset of process data to provide a third subset of process data.

The invention also provides, in specific embodiments, a method for analyzing clinical pathways. This method comprises a variety of elements. For example, abstracting clinical data into three or more dimensions, comprising a patient dimension, a time dimension, and a procedure dimension is part of the method. The method includes providing a two dimensional presentation of the clinical data and a one dimensional presentation of the clinical data, enabling visualization of the clinical data in one or more dimensions. The method further includes indicating a correlation between two or more of the three dimensions using the two dimensional presentation, and indicating a quantity measure by one or more of the three dimensions using the one dimensional presentation. Receiving a selection of one or more of a plurality of regions of interest (ROI), from at least one of the three dimensions, is also included in the method. The selection can be indicated on one or both of the two dimensional presentation and the one dimensional presentation. The method further provides for exchanging information about the selected ROI between the two dimensional presentation and the one dimensional presentation. Then, calculating a first subset of the process data, comprising values present in the ROI along one or more of the three dimensions is performed according to the method. Then, the two dimensional presentation and the one dimensional presentation are redrawn based upon the first subset of the process data.

The invention also provides some graph types to easily compare the patterns of selected regions: (1) a 2-dimensional map that shows the difference of two regions, (2) a 2-dimensional map in which color represents the intensities of selected regions, and (3) at least two 2-dimensional maps that show each pattern that corresponds to each selected region.

The invention also provides flexible sorting or categorizing in the graphs to allow users to select ROIs. The invention also provides the system that integrates a data retrieval part from warehoused data, a data distribution part, and a data analysis part that includes this visualization technique.

### BRIEF DESCRIPTION OF THE DRAWINGS

FIG. 1 illustrates a schematic diagram of a specific embodiment according to the present invention.

FIG. 2 illustrates a flow chart of a selection function in a specific embodiment according to the present invention.

FIG. 3 illustrates a representative screen image of a computer display in a specific embodiment according to the present invention.

FIG. 4 illustrates one technique for displaying information about some selected ROIs on the 2D-map in a specific embodiment according to the present invention.

FIG. 5 illustrates a technique for displaying the information on certain selected ROIs on a 1D-graph in a specific embodiment according to the present invention.

FIG. 6 illustrates another technique for displaying the information on certain selected ROIs on a 1D-graph in a specific embodiment according to the present invention.

FIG. 7 illustrates an example of categorizing a patient axis in a specific embodiment according to the present invention.

FIG. 8 illustrates a representative system suitable for embodying the present invention.

FIG. 9 illustrates a representative display image of an example analysis in a representative embodiment according to the present invention.

### DESCRIPTION OF THE SPECIFIC EMBODIMENTS

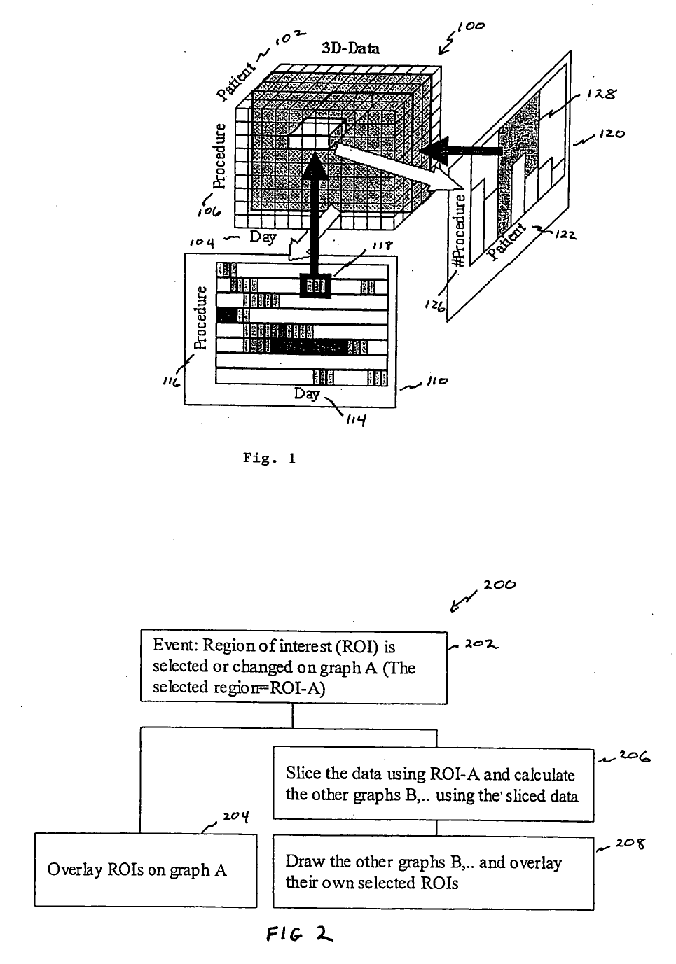

FIG. 1 illustrates a schematic diagram of a specific embodiment according to the present invention. A cube 100 shown in FIG. 1 represents multidimensional data. According to the invention, process data is abstracted into a cube having three dimensions. For example, the dimensions can include a patient, a time and a type of procedure. In the embodiment illustrated by FIG. 1, the three dimensions comprise a patient 102, a day, measured from the day of admission 104, and a type of procedure 106. The patient and the type of procedure dimensions are discrete data, while the day from admission can be thought of as continuous data. FIG. 1 also illustrates a 2-dimensional map 110 (2D-map, or 2D-matrix) that shows the projection of multidimensional data onto two dimensions. The two axes of 2D-map are a time 114 and a type of procedure 116. In a specific embodiment, the brightness of each pixel shows the frequency of procedures used. For example, greater brightness in the pixel indicates a higher frequency of use for a particular procedure. FIG. 1 further illustrates a 1-dimensional graph (1D-graph) 120 that shows the number of procedures used 126 for one or more particular patients 122. Thus, the 2D-map 110 shows the integral pattern of each process applied to a patient. Whereas, the 1D-graph 120 shows the total number of procedures applied to a patient.

According to the present invention, a user can select the ROI on each of the graphs, for example, and the information of the ROI is interchanged and the multidimensional data is sliced according to the selected ROI. The ROI is typically set as a subset of the value taken in the dimensions. For example, in FIG. 1, a user selects a ROI 128 on the 1D-graph, 120 which selects a subgroup of patients. Then, an integrated process pattern applied to this subset of patients is calculated. The 2D-map 110 is redrawn according to the result of this calculation, and it can show a particular pattern corresponding to this subset. On the other hand, if the user selects a ROI 118 on the 2D-map 110, then the number of procedures, of which (time, type) are included in the ROI, are calculated and displayed on the 1D-graph.

FIG. 2 illustrates a flow chart 200 of a selection function in a specific embodiment according to the present invention. In a step 202, if the user selects or changes the ROI, then in a step 204, the selected ROI is overlaid on the graph. In a step 206, the multidimensional data is sliced according to the ROI. Then, in a step 208, the other graphs are re-calculated according to the sliced multidimensional data. A key feature of specific embodiments is that these embodiments enable users (1) to slice the multidimensional data while seeing the summarized information in particular dimension(s), and (2) to see the results of slicing from the view of the other dimension(s).

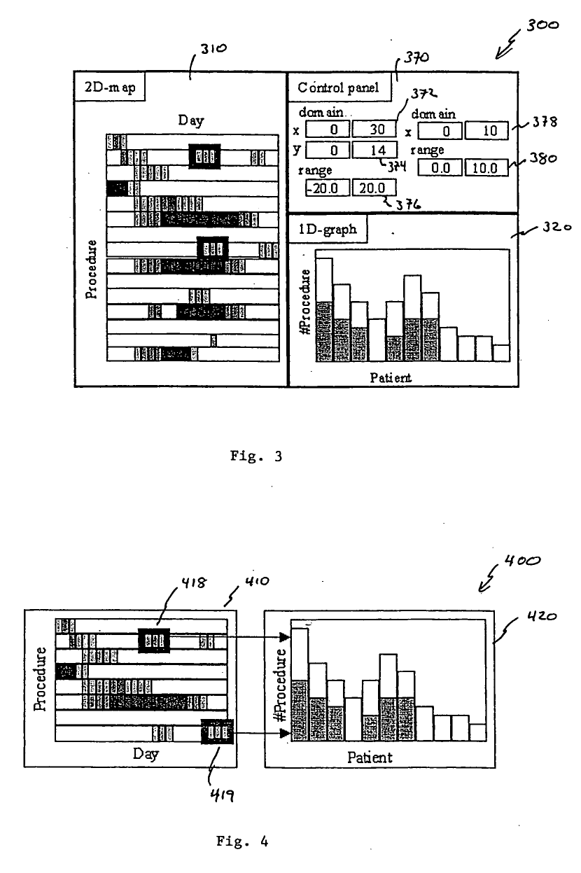

FIG. 3 illustrates a representative screen image of a computer display in a specific embodiment according to the present invention. In FIG. 3, a screen image 300 comprises two types of visualization devices (2D-map 210 and 1D-graph 320) and a control panel 370 to configure each visualization device. The control panel 370 provides control of an x-axis domain 372, a y-axis domain 374 and a range 376 of the 2D-map 310, and a domain 378 and a range 380 of the 1D-graph 320. It also provides controls (not shown) for the brightness and contrast of 2D-map, the color table of 2D-map, 1D-graph type, and so on. By using pointing devices, such as a mouse or a touch panel, ROIs can be selected on the 2D-map 310 and the 1D-graph 320. By using an input device, such as a keyboard, the maps and graphs can be configured through the control panel 370. Simultaneous display of the control panel 370 and the 2D-map 310 or the 1D-graph 320 is not necessary.

The invention also provides for a plurality of presentation techniques for maps and graphs. While illustrated using a representative embodiment having two visualization devices, a map and a graph, the present invention is not limited to a specific number of maps or graphs. Furthermore, a combination of visualization device types is not limited to the 2D-map and the 1D-graph. For example, the 1D-graph 320 can be replaced by a second 2D-map to show 4-dimensional data, or the 2D-map 310 can be replaced by a 2D-scatter graph to show the distribution of data. Accordingly, embodiments of the present invention allow users to select appropriate map and/or graph types for the data. The invention also provides a plurality of techniques for selecting the ROI. In FIG. 1, the ROI is an inner-region of a rectangle that the user selects. However, the ROI can be set as an outer-region, an outer-region for one-dimension and an inner-region for another dimension, a region having coordinates outside of the rectangle, and so on. Specific embodiments employing this feature provide users with flexibility in selecting the ROI. For example, the user can select as the ROI, “all procedures after three days from admission.”

The invention also provides alternative ways to set the ROI. The ROI can be set using a threshold in one or more values. For example, the user can set a lower threshold value in a 2D-map, then the ROI on the 2D-map is set as the cells where its value is above the threshold. This enables users to set the ROI according to a normal course of clinical procedure. Specific embodiments providing this function can enable the user to easily determine which patients did not have the normal course of clinical procedure applied to them, for example.

The invention also provides a plurality of techniques for comparing the selected regions. FIG. 4 illustrates a diagram 400 of one technique for displaying information about some selected ROIs of a 2D-map in a specific embodiment of the present invention. A first ROI 418 and a second ROI 419 are selected on the left side of the 2D-map 410. These two ROIs correspond to a 1D-graph 420 on the right side of FIG. 4. This enables comparison of the two regions to be made relatively more easily. The number of ROIs and the corresponding number of graphs is not limited to two. It is possible to use more than two ROIs and graphs in specific embodiments.

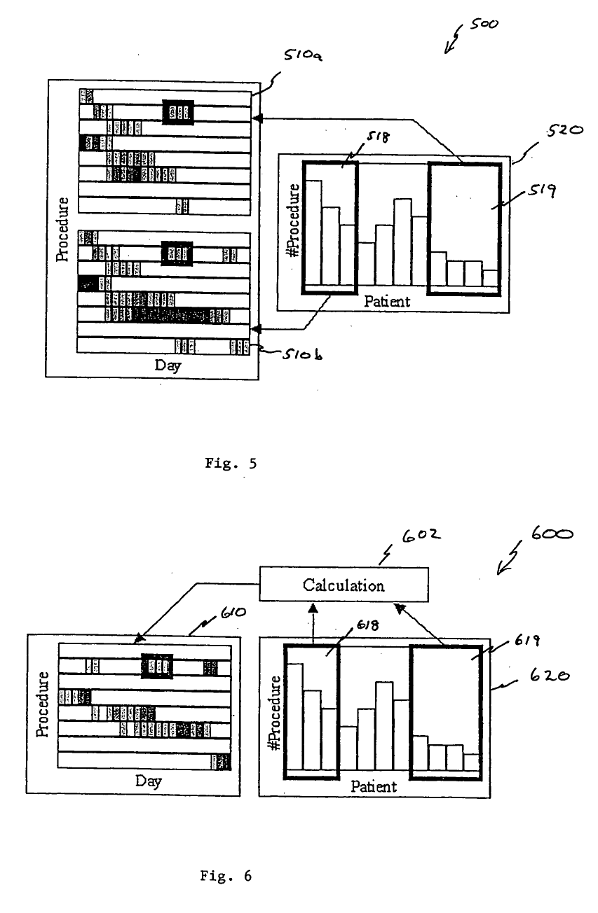

FIG. 5 illustrates a diagram 500 of a technique for displaying the information on certain selected ROIs on a 1D-graph 520 in a specific embodiment according to the present invention. A first ROI 518 and a second ROI 519 are selected in the 1D-graph 520 on the right side of FIG. 5. These two ROIs correspond to two individual 2D-maps 510a, 510b on the left side of FIG. 5. This technique enables users to distinguish the difference in patterns between the two 2D-maps. For example, if the user selects two physicians on the 1D-graph 520, then the user can compare each physician's procedure pattern on the 2D-maps 510a, 510b. The number of ROIs and the corresponding number of maps is not limited to two. It is possible to use more than two ROIs and maps in specific embodiments.

FIG. 6 illustrates a diagram 600 of another technique for displaying the information on certain selected ROIs in a specific embodiment according to the present invention. FIG. 6 depicts a first ROI 618 and a second ROI 619 selected in the 1D-graph 620. A calculation 602 is performed on the ROIs 618 and 619, and the result is displayed on the 2D-map 610 on the left side of FIG. 6. The calculation 602 can be a subtraction of the first ROI 618 from the second ROI 619, for example, which enables displaying the difference between the two ROIs using, for example, the color and brightness of the 2D-map 610. The calculation 602 can apply a function, such as an addition, a subtraction, a multiplication, an exponentiation, a division, a root, a boolean operator, a modulo, an absolute value, and the like. In a specific embodiment, brightness of red and blue color can be used for positive and negative values, for example. Accordingly, ROIs 618, 619 can be compared by using the intensity of colors on the 2D-map 610. In a representative example embodiment, if a user selects two patient groups, then the user can see the procedure used particularly in one group drawn as bright red or blue, for example, and the procedure used in both of the groups drawn in a dark color, or the like. Results of the calculation 602 can be used to set RGB colors representing the intensity of each of the ROIs. In this embodiment, the red pixel, for example, on the 2D-map 610 shows the higher value in the region corresponding to the red color. Accordingly, users can distinguish the difference among the ROIs by the color.

The invention also provides a plurality of techniques for categorizing the items by dimensions. FIG. 7 illustrates a diagram 700 of an example of categorizing a patient axis in a specific embodiment according to the present invention. In FIG. 7, a patient axis 702 can be categorized by physician, diagnostics, age, admitting date, and so on. A procedure axis 706 can be categorized by the department, operating room, pharmacy and so on. This categorization allows users to easily grasp the data from higher levels of a hierarchy for each dimension.

The invention also provides several values to be displayed. In FIG. 1, the frequency of procedures is displayed. Cost and profit can be displayed, as well. The displayed values can differ among various maps and/or graphs. For example, if frequency is displayed on a 2D-map and cost is displayed on a 1D-graph, then the user can analyze the frequency pattern of a procedure while seeing the cost of patients. These values can be calculated as a summation in the ROI, or as an average in the ROI. For example, this function enables analyzing the average profitability from the procedure level.

The invention is also applicable to data models having more than three dimensions. Further, users can change the axes of multiple graphs, individually or at the same time.

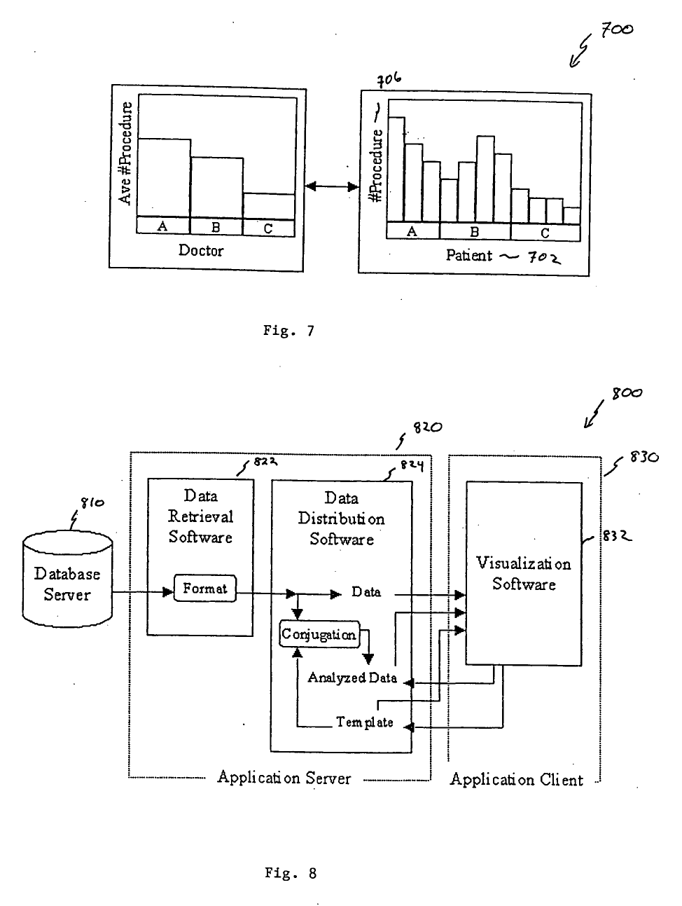

FIG. 8 illustrates a representative system suitable for embodying the present invention. In FIG. 8, the arrows represent the data flow. The system shown in FIG. 8 comprises a database server 810, an application server 820 and an application client 830. The database server 810 stores and supplies data. A relational database or a multidimensional database, for example, can be used to store and supply the data. The application server 820 performs data retrieval and data distribution. In a specific embodiment, these functions are implemented by data retrieval software 822 and data distribution software 824. The data retrieval software 822 retrieves the data, formats it and passes it to the data distribution software 824. This action is triggered by a request from the data distribution software 824, by preset schedule, or the like. The data distribution software 824 receives the formatted data from the data retrieval software 822, stores the formatted data, and passes the formatted data to the application client software 832. It also stores analyzed data and a template that are created by the application client 830. The data distribution software 824 can conjugate formatted data and templates to make analyzed data. The data distribution software 824 can distribute data, analyzed data, and templates responsive to a request from the application client 830 or by preset schedule. The data distribution software 824 controls which data should be sent to the application client 830 taking update timing of data and security into account.

The application client software 832 provides users the analysis environment described above. The application client software 832 can store analyzed data and template, in a client machine, as well as in the application server 820 through the data distribution software 824. This system enables users to distribute and share the results of analyses. It also reduces the loading of the database server 810 by storing some of the analyzed data at the application server 820.

Furthermore, this system can be modified to improve the performance. In this example, the application server 820 sends whole multidimensional data to the application client 830. In another embodiment, the application client 830 displays multiple maps and/or graphs, while the application server 820 performs calculations such as data slicing or categorization. In this embodiment, the size of data translation is relatively less than in other embodiments, as one-dimensional or two-dimensional data are sent from the application server 820 to the application client 830. This modification can also reduce a performance requirement for client computers. FIG. 8 also illustrates a representative format for storing data, information about ROI and categorization in a specific embodiment according to the present invention. The data and the information about ROIs or categorization are separated. The latter environmental part can be stored apart and can be used as a template. This enables users to reuse the setting of ROIs and categorizations, which leads to reduction of user operations. For example, users can reuse the template even when the data itself is updated. The number of ROIs is not limited to two. It is possible to use more than two ROIs in specific embodiments.

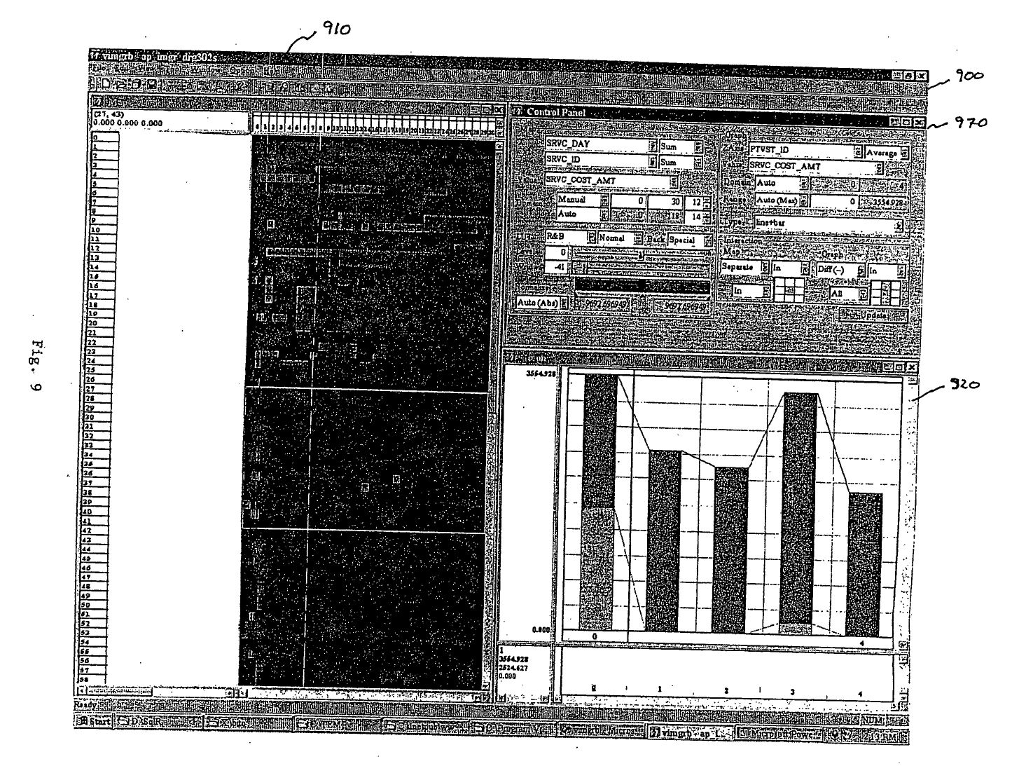

FIG. 9 illustrates a representative display image of an example analysis in a representative embodiment according to the present invention. FIG. 9 illustrates a screen image 900 that comprises two types of visualization devices, a 2D-map 910 and a 1D-graph 920, and a control panel 970 to configure each map or graph. Function of these components is analogous to correspondingly identified components in the screen image 300 of FIG. 3, and reference may be had to the description of these components of FIG. 3 for description of the corresponding components of FIG. 9.

The preceding has been a description of the preferred embodiment of the invention. The present invention has been discussed generally with respect to example embodiments related to analyzing the course of clinical procedure. However, the invention is not limited to this purpose. It can be used for analyzing processes of many different types and it can be used for any analyzing a variety of multidimensional data. It will be appreciated that deviations and modifications can be made without departing from the scope of the invention, which is defined by the appended claims.

What is claimed is:

1. A method for analyzing process data, said method comprising:
displaying said process data in a first image, said first image representing first and second dimensions associated with said process data;
displaying said process data in a second image, said second image representing a third dimension associated with said process data;
receiving a region of interest (ROI) selected from one of said first image and said second image, wherein said ROI can be from said first image or from said second image;
calculating a first subset of said process data, said first subset comprising values present in said selected ROI; and
redrawing one of said first image and said second image based upon said first subset of said process data, wherein said first image is redrawn if said ROI is from said second image and said second image is redrawn if said ROI is from said first image.

2. The method for analyzing process data of claim 1, wherein one of said first, second, and third dimensions comprising at least one of a process dimension, a time dimension, and a type of procedure dimension.

3. The method for analyzing process data of claim 1, said first image and said second image each comprising at least one of a two-dimensional map and a one-dimensional graph.

4. The method for analyzing process data of claim 1, said first image and said second image comprising a first two-dimensional map and a second two dimensional map indicating four-dimensional data.

5. The method for analyzing process data of claim 1, said first image and said second image each comprising a 2D-scatter graph indicating a distribution of said process data.

6. The method for analyzing process data of claim 5, said one-dimensional graph comprising at least one of a bar graph and a line graph.

7. The method for analyzing process data of claim 1, further comprising indicating at least one correlation between said three dimensions using a third image.

8. The method for analyzing process data of claim 7, further comprising displaying at least two of said first image, said second image and said third image on a computer screen.

9. A method for analyzing clinical pathways, said method comprising:
providing a two dimensional presentation of clinical data and a one dimensional presentation of said clinical data, thereby enabling visualization of said clinical data in at least one of three or more dimensions, including a patient dimension, a time dimension, and a procedure dimension;
receiving a selection of a region of interest (ROI), said selection from at least one of said two dimensional presentation and said one dimensional presentation, wherein said ROI can be from said two dimensional presentation or from said one dimensional presentation;
calculating a first subset of said process data, said first subset comprising values present in said ROI along at least one of said three dimensions; and
redrawing one of said two dimensional presentation and said one dimensional presentation based upon said first subset of said process data, wherein said two dimensional presentation is redrawn if said ROI is from said one dimensional presentation and said one dimensional presentation is redrawn if said ROI is from said second presentation.

10. The method for analyzing clinical pathways of claim 9, said two dimensional presentation comprising a map.

11. The method for analyzing clinical pathways of claim 9, said one dimensional presentation comprising a graph.

12. A computer program product for analyzing process data, said computer program product comprising:
code that displays said process data in a first image, said first image representing first and second dimensions associated with said process data;
code that displays said process data in a second image, said second image representing a third dimension associated with said process data;
code that receives a region of interest (ROI) selected from one of said first image and said second image, wherein said ROI can be from said first image or from said second image;
code that calculates a first subset of said process data, said first subset comprising values present in said ROI along at least one of said three dimensions;
code that redraws said first image based upon said first subset of said process data if said ROI is from said second image;
code that redraws said second image based upon said first subset of said process data if said ROI is from said first image; and
a computer readable storage device for containing the codes.

13. An apparatus for analyzing process data, said apparatus comprising:
a processor,
a display device,
a persistent storage, and
a bus, said bus interconnecting said processor, said display device and said persistent storage, wherein said processor:
displays said process data in a first image, said first image representing first and second dimensions associated with said process data;
displays said process data in a second image, said second image representing a third dimension associated with said process data;
receives a region of interest (ROI) selected from one of said first image and said second image, wherein said ROI can be from said first image or from said second image;
calculates a first subset of said process data, said first subset comprising values present in said ROI along at least one of said three dimensions; and
redraws one of said first image and said second image based upon said first subset of said process data, wherein said first image is redrawn if said ROI is from said second image and said second image is redrawn if said ROI is from said first image.

14. An apparatus for analyzing process data, said apparatus comprising:
means for displaying said process data in a first image, said first image representing first and second dimensions associated with said process data;
means for displaying said process data in a second image, said second image representing a third dimension associated with said process data;
means for receiving a region of interest (ROI) selected from one of said first image and said second image, wherein said ROI can be from said first image or from said second image;
means for calculating a first subset of said process data, said first subset comprising values present in said ROI along at least one of said three dimensions; and
means for redrawing one of said first image and said second image based upon said first subset of said process data, wherein said first image is redrawn if said ROI is from said second image and said second image is redrawn if said ROI is from said first image.

15. A system for analyzing process data, said system comprising:
a database server,
an application client, in communication with said application server,
an application server, in communication with said application server and said application client; wherein
said application server abstracts said process data stored in said database server into at least three dimensions and forwards said abstracted process data to said application client; and wherein
said application client provides a plurality of images, including a first image and a second image, said plurality of images enabling visualization of said process data in at least one of said three dimensions; wherein at least one correlation between at least two of said three dimensions is indicated using said first image and a quantity measure in at least one of said three dimensions is indicated using said second image; and wherein
said application client receives a selection of at least one region of interest (ROI) selected from one of said first image and said second image, wherein said ROI can be from said first image or from said second image; and wherein
said application client calculates a first subset of said process data, said first subset comprising values present in said ROI along at least one of said three dimensions; and wherein
said application client redraws at least one of said first image and said second image based upon said first subset of said process data, wherein said first image is redrawn if said ROI is from said second image and said second image is redrawn if said ROI is from said first image.

16. A method for analyzing process data, said method comprising:
abstracting said process data into at least three dimensions;
providing a plurality of visualization devices, including a first visualization device and a second visualization device, said plurality of visualization devices enabling visualization of said process data in at least one of said three dimensions;
indicating at least one correlation between at least two of said three dimensions in said first visualization device;
indicating a quantity measure by at least one of said three dimensions in said second visualization device;
receiving a selection of at least one of a plurality of regions of interest (ROI), said selection from at least one dimension chosen from among said three dimensions, said selection indicated on at least one of said first visualization device and said second visualization device, wherein said ROI can be from said first visualization device or from said second visualization device;
calculating a first subset of said process data, said first subset comprising values present in said ROI; and
redrawing said first visualization device if said ROI is from said second visualization device and redrawing said second visualization device if said ROI is from said first visualization device.

17. The method of claim 16 further comprising:
receiving a second selection of at least one of said plurality of regions of interest (ROI), said second selection from at least one dimension chosen from among said three dimensions, said second selection indicated on at least one of said first visualization device and said second visualization device;
calculating a second subset of said process data, said second subset comprising values present in said second selection of at least one of said plurality of regions of interest along at least one of said three dimensions; and
displaying said first subset of said process data and said second subset of said process data together using at least one of said first visualization device and said second visualization device.

18. A method for analyzing process data, said method comprising:
abstracting said process data into at least three dimensions;
providing a plurality of visualization devices, including a first visualization device and a second visualization device, said plurality of visualization devices enabling visualization of said process data in at least one of said three dimensions;
indicating at least one correlation between at least two of said three dimensions in said first visualization device;
indicating a quantity measure by at least one of said three dimensions in said second visualization device;
receiving a selection of at least one of a plurality of regions of interest (ROI), said selection from at least one dimension chosen from among said three dimensions, said selection indicated on at least one of said first visualization device and said second visualization device, wherein said ROI can be from said first visualization device or from said second visualization device;
calculating a first subset of said process data, said first subset comprising values present in said ROI; and
redrawing said first visualization device if said ROI is from said second visualization device and redrawing said second visualization device if said ROI is from said first visualization device.

19. The method of claim 18 further comprising:
receiving a second selection of at least one of said plurality of regions of interest (ROI), said second selection from at least one dimension chosen from among said three dimensions, said second selection indicated on at least one of said first visualization device and said second visualization device;
calculating a second subset of said process data, said second subset comprising values present in said second selection of at least one of said plurality of regions of interest along at least one of said three dimensions; and
applying a function to said first subset of said process data and said second subset of said process data, yielding a third subset of said process data; and
displaying said third subset of said process data together using at least one of said first visualization device and said second visualization device.

20. A method for analyzing process data, said method comprising:
abstracting said process data into at least three dimensions;
providing a plurality of visualization devices, including a first visualization device and a second visualization device, said plurality of visualization devices enabling visualization of said process data in at least one of said three dimensions;
indicating at least one correlation between at least two of said three dimensions in said first visualization device;
indicating a quantity measure by at least one of said three dimensions in said second visualization device;
receiving a selection of at least one of a plurality of regions of interest (ROI), said selection from at least one dimension chosen from among said three dimensions, said selection indicated on at least one of said first visualization device and said second visualization device;
calculating a first subset of said process data, said first subset comprising values present in said ROI; and
redrawing at least one of said first visualization device and said second visualization device based upon said first subset of said process data, wherein said first visualization device is redrawn if said ROI is from said second visualization device and said second visualization device is redrawn if said ROI is from said first visualization device.

21. The method of claim 20 further comprising displaying at least one of a plurality of categorizations of at least one of said three dimensions of said process data in at least one of said first visualization device and said second visualization device.

22. A method for analyzing process data, said method comprising:
abstracting said process data into at least three dimensions;
providing a plurality of visualization devices, including a first visualization device and a second visualization device, said plurality of visualization devices enabling visualization of said process data in at least one of said three dimensions;
indicating at least one correlation between at least two of said three dimensions in said first visualization device;
indicating a quantity measure by at least one of said three dimensions in said second visualization device;
receiving a selection of at least one of a plurality of regions of interest (ROI), said selection from at least one dimension chosen from among said three dimensions, said selection indicated on at least one of said first visualization device and said second visualization device;
calculating a first subset of said process data, said first subset comprising values present in said ROI;
receiving a second selection of at least one of said plurality of regions of interest (ROI), said second selection from at least one dimension chosen from among said three dimensions, said second selection indicated on at least one of said first visualization device and said second visualization device;
calculating a second subset of said process data, said second subset comprising values present in said second selection of at least one of said plurality of regions of interest along at least one of said three dimensions;
applying a function to said first subset of said process data and said second subset of said process data, yielding a third subset of said process data; and
displaying said third subset of said process data together using at least one of said first visualization device and said second visualization device,
said function comprising at least one of an addition, a subtraction, a multiplication, an exponentiation, a division, a root, a boolean operator, a modulo, and an absolute value.

23. A method for analyzing process data, said method comprising:
abstracting said process data into at least three dimensions;
providing a plurality of visualization devices, including a first visualization device and a second visualization device, said plurality of visualization devices enabling visualization of said process data in at least one of said three dimensions;
indicating at least one correlation between at least two of said three dimensions in said first visualization device;
indicating a quantity measure by at least one of said three dimensions in said second visualization device;
receiving a selection of at least one of a plurality of regions of interest (ROI), said selection from at least one dimension chosen from among said three dimensions, said selection indicated on at least one of said first visualization device and said second visualization device;
calculating a first subset of said process data, said first subset comprising values present in said ROI;
receiving a second selection of at least one of said plurality of regions of interest (ROI), said second selection from at least one dimension chosen from among said three dimensions, said second selection indicated on at least one of said first visualization device and said second visualization device;
calculating a second subset of said process data, said second subset comprising values present in said second selection of at least one of said plurality of regions of interest along at least one of said three dimensions;
applying a function to said first subset of said process data and said second subset of said process data, yielding a third subset of said process data; and
displaying said third subset of said process data together using at least one of said first visualization device and said second visualization device,
said third subset of said process data displayed using at least one of a plurality of different colors, a plurality of different intensities of a color, a plurality of different intensities of a plurality of different colors.
